(19) United States
(12) Patent Application Publication
(10) Pub. No.: US 2008/0045053 A1
(43) Pub. Date: Feb. 21, 2008

(54) Contact element for connecting an electrical conductor

(75) Inventors: Hermann Stadler, Donaueschingen (DE); Heiko Ullrich, Blumberg (DE); Axel Fechner, St. Georgen (DE)

Correspondence Address: NATH & ASSOCIATES, 112 South West Street, Alexandria, VA, 22314, US

(73) Assignee: MC TECHNOLOGY GmbH, Blumberg (DE)

(21) Appl. No.: 11/812,560

(22) Filed: Jun. 20, 2007

(30) Foreign Application Priority Data
Jun. 21, 2006 (DE) 10 2006 028 814.9

(51) Int. Cl. H01R 12/04

(52) U.S. Cl. 439/82; 439/55; 439/78

(57) ABSTRACT

The patent application relates to a contact element (10) for connecting an electrical conductor (30), comprising a flat electrically conductive base element (12) in which at least one passage (14a, 14b, 14c, 14d, 14e, 14f, 14g) is provided, the smallest diameter (15a, 15b, 15c, 15d, 15e, 15f, 15g) of which is smaller than the diameter of the electrical conductor (30), and at its free end (18a, 18b, 18c, 18d, 18e, 18f, 18g) at least one contact lug (16a, 16b, 16c, 16d, 16e, 16f, 16g) adjoins the passage (14a, 14b, 14c, 14d, 14e, 14f, 14g), and the contact lug (16a, 16b, 16c, 16d, 16e, 16f, 16g) being designed in such a way that when an electrical conductor (30) is inserted, the contact lug lies with its free end (18a, 18b, 18c, 18d, 18e, 18f, 18g) against the electrical conductor (30).

The invention relates to a contact element for connecting an electrical conductor.

For joining connecting wires to a printed circuit board, for example, at the conductors the connecting wires are soldered or connected to the printed circuit board by means of printed circuit board clips. Printed circuit board clips based on a screw, spring, or insulation displacement clip are known. The contact elements for the spring clips are generally composed of a correspondingly bent metallic band such as a cage tension spring, for example.

Printed circuit board clips having screw clamping are often cumbersome to operate. The contact elements for the spring clips are sometimes difficult to manufacture due to the variations in the bending process, which require a comparatively large quantity of metallic material.

The object of the invention, therefore, is to provide a contact element which is easily and economically manufactured and which allows an electrical conductor to be easily connected.

The object of the invention is achieved by a contact element having the features of claim 1. The object of the invention is further achieved by a method for connecting an electrical conductor, having the features of claim 11.

Advantageous embodiments and refinements of the invention are stated in the subclaims.

The contact element according to the invention for connecting an electrical conductor has a flat electrically conductive base element in which at least one passage is provided, the smallest diameter of which is smaller than the diameter of the electrical conductor, and at least one contact lug, the free end of which adjoins the passage, is designed such that when an electrical conductor is inserted, the contact lug at its free end rests against the electrical conductor. A passage refers to the region through which the electrical conductor may be inserted by use of the contact element. The passage is essentially delimited by the free ends of the contact lugs, regardless of whether the contact lugs lie in the plane of the base element or are bent outward from the plane of the base element. On the one hand the contact element is very easily manufactured, since it can essentially be fabricated from a flat, for example rectangular, electrically conductive piece of material in which the passage and the at least one contact lug are punched into the base element by means of a punching process. On the other hand, a very simple possibility is afforded for connecting an electrical conductor, since the electrical conductor need only be inserted into the opening, whereby the contact lug, if it still lies in the plane of the base element after the manufacturing process, is bent outward from the plane of the base element, or, if it is already bent outward from the plane of the base element by a certain angle, the contact lug is bent further upward until its free end rests against the electrical conductor, thereby ensuring electrical contact of the electrical conductor. For this reason the contact lugs are preferably designed as leaf spring-like elements. In addition, the electrical conductor can be removed from the contact element only with great difficulty, thereby allowing the electrical conductor to be secured. Furthermore, the contact element according to the invention has the advantage that it may be mounted on the printed circuit board using customary pick-and-place devices, and may be soldered in the reflow process.

It is preferred that two to eight contact lugs at their free ends adjoin the passage, thereby ensuring a good electrically conductive contact between the electrical conductor and the contact element via multiple contact points.

In one advantageous refinement of the invention, multiple, preferably at least three, passages are provided in the base element, so that multiple, preferably at least three, electrical conductors may be connected in a base element, thus allowing an electrically conductive connection between multiple electrical conductors. The contact element is therefore particularly suited as a shorting clip.

The contact element is preferably designed as a punched element, thus allowing particularly simple manufacture of the contact element.

The contact element may be mounted on a printed circuit board in a particularly simple manner, for example using the SMD technique, by placing the flat contact element on a corresponding contact surface of the printed circuit board and fastening it at that location by soldering, for example. Alternatively, the contact element additionally has at least one connecting pin, preferably perpendicular to the plane of the base element, by means of which the contact element may be fastened to a printed circuit board in the perforation technique. In both alternatives the contact element may be mounted directly on the printed circuit board, thus allowing a compact contact.

In one advantageous refinement of the invention, the contact element is situated in an insulating housing, and input openings are provided in the housing in such a way that the electrical conductor may be pushed through the input openings of the housing and into the passages in the base element. The insulating housing has the advantage that release openings may also preferably be provided therein so that a release tool may be pushed through same against at least one contact lug for the base element in order to deflect the at least one contact lug and release it from the inserted electrical conductor to enable removal of the electrical conductor from the contact element without damage. The release tool may be a screwdriver, for example, by means of which the contact lug is merely pushed away from the electrical conductor. However, it is preferred that in at least one release opening a release tool is provided which has an end to be applied to the contact lug, and an actuation end which may be displaced in the release opening, the end to be applied against the contact lug being situated in the housing and the actuation end being situated outside the housing. The release tool is thus permanently installed in the release opening, so that it is not necessary to find an appropriate tool when the electrical conductor is to be released from the contact element.

The release tool preferably has a wedge-shaped design at the end to be applied against the contact lug to enable particularly simple engagement between the electrical conductor and the contact lug resting against the electrical conductor, or between multiple contact lugs resting against the electrical conductor, and to enable the contact lug(s) to be pushed away from the electrical conductor to allow removal of the electrical conductor from the contact element without resistance.

The contact element according to the invention is preferably used for connecting an electrical conductor. The electrical conductor is designed in particular as a connecting wire, and is preferably connected to a printed circuit board.

In the method according to the invention for connecting an electrical conductor, first an electrically conductive contact element is mounted on a substrate element, for example a printed circuit board or an insulating housing, the contact element having a passage whose smallest diameter is smaller than the diameter of the conductor, whereby at its free end at least one contact lug adjoins the passage. The conductor is then guided through the passage, whereby the at least one contact lug, if it still lies in the plane of the base element during the manufacturing process, is bent outward from the plane of the base element, or, if the contact lug is already bent outward from the plane, it is bent further upward until its free end rests against the electrical conductor. The electrical conductor is then held in a clamped manner by the at least one contact lug, thereby establishing the electrical contact via the contact lug for the contact element.

The invention is explained in detail with reference to the figures, which show the following:

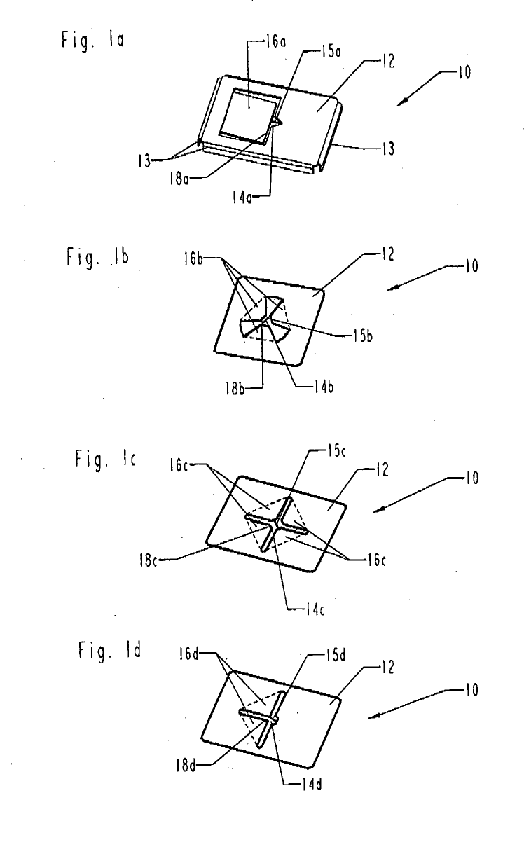

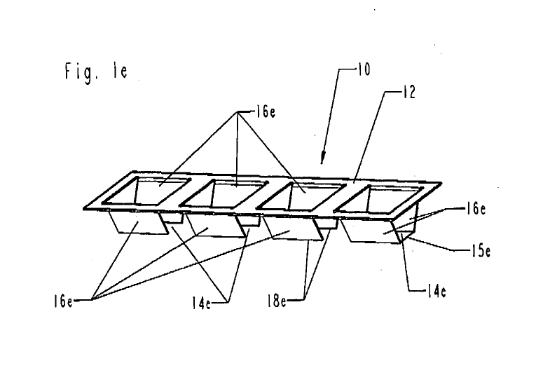

FIG. 1a shows a perspective view of a first exemplary embodiment of a contact element;

FIG. 1b shows a perspective view of a second exemplary embodiment of a contact element;

FIG. 1c shows a perspective view of a third exemplary embodiment of a contact element;

FIG. 1d shows a perspective view of a fourth exemplary embodiment of a contact element;

FIG. 1e shows a perspective view of a fifth exemplary embodiment of a contact element;

FIG. 1f shows a perspective view of a sixth exemplary embodiment of a contact element;

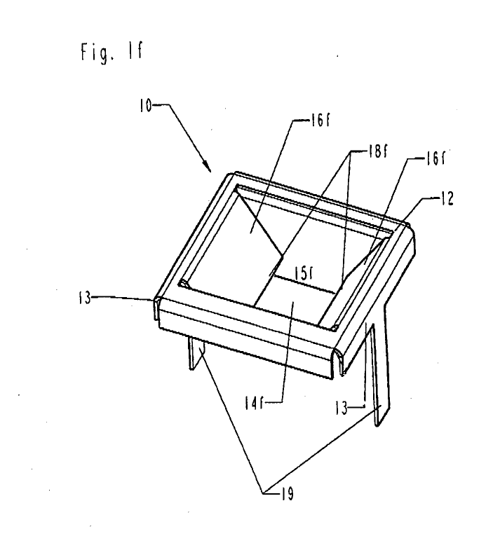

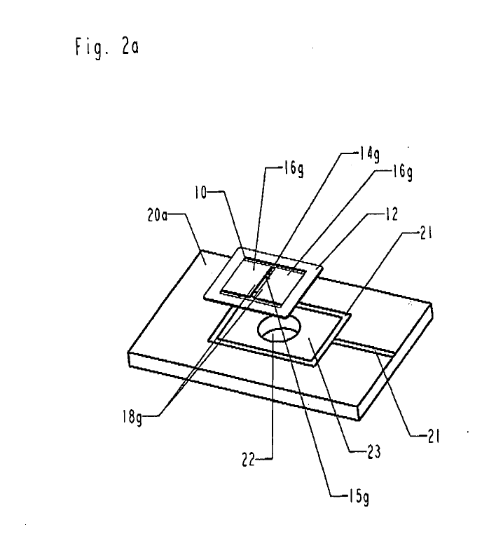

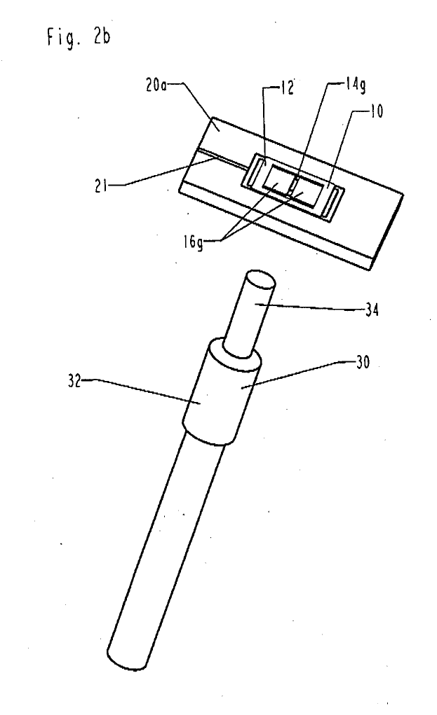

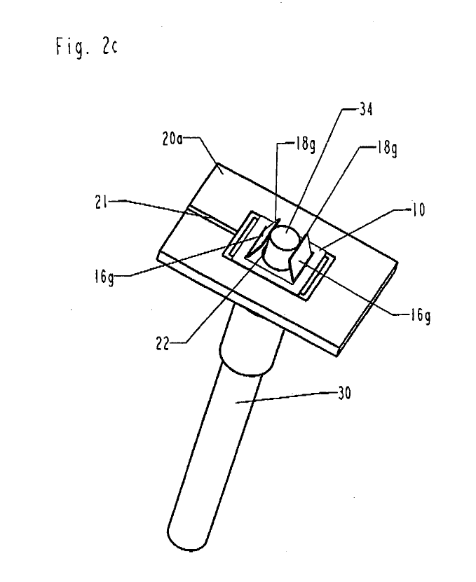

FIG. 2a shows a schematic illustration of the step of mounting a seventh exemplary embodiment of a contact element on a printed circuit board;

FIG. 2b shows a schematic illustration of the step of inserting an electrical conductor into the contact element mounted on the printed circuit board, according to FIG. 2;

FIG. 2c shows a schematic illustration of the electrical conductor connected to the printed circuit board via the contact element, according to FIG. 2a;

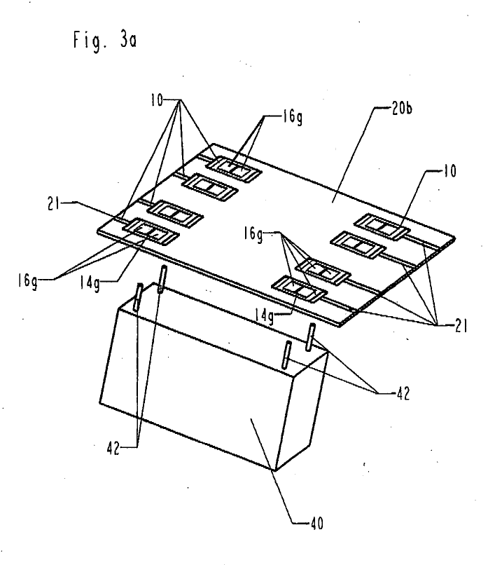

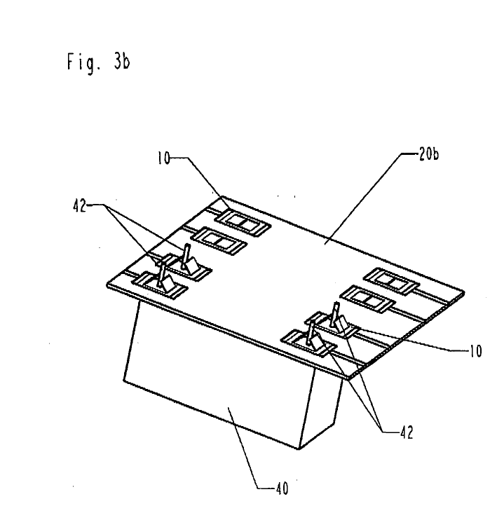

FIG. 3a shows a perspective view of a component to be connected to a printed circuit board;

FIG. 3b shows a component according to 3a in the state of connection to the printed circuit board;

FIG. 4a shows a partial cutaway perspective view of the contact element according to FIG. 1e, situated in a housing;

FIG. 4b shows a perspective view of the housing together with the contact element according to FIG. 4a;

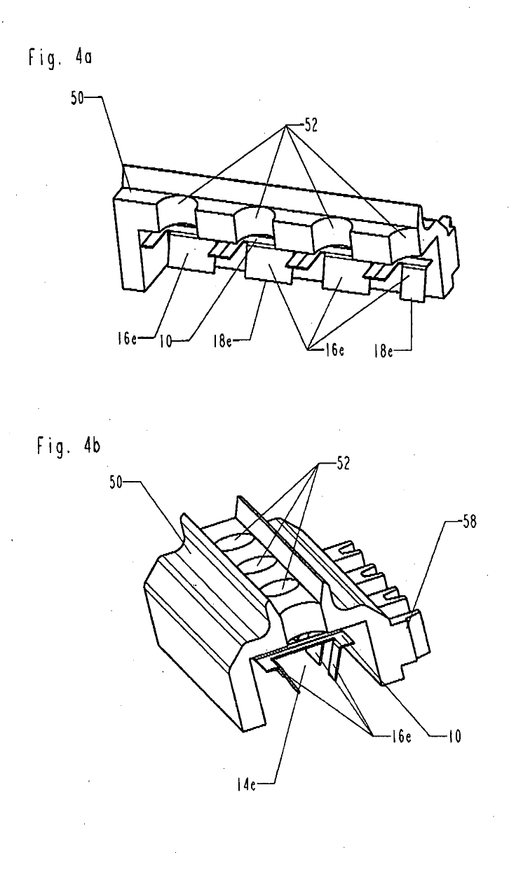

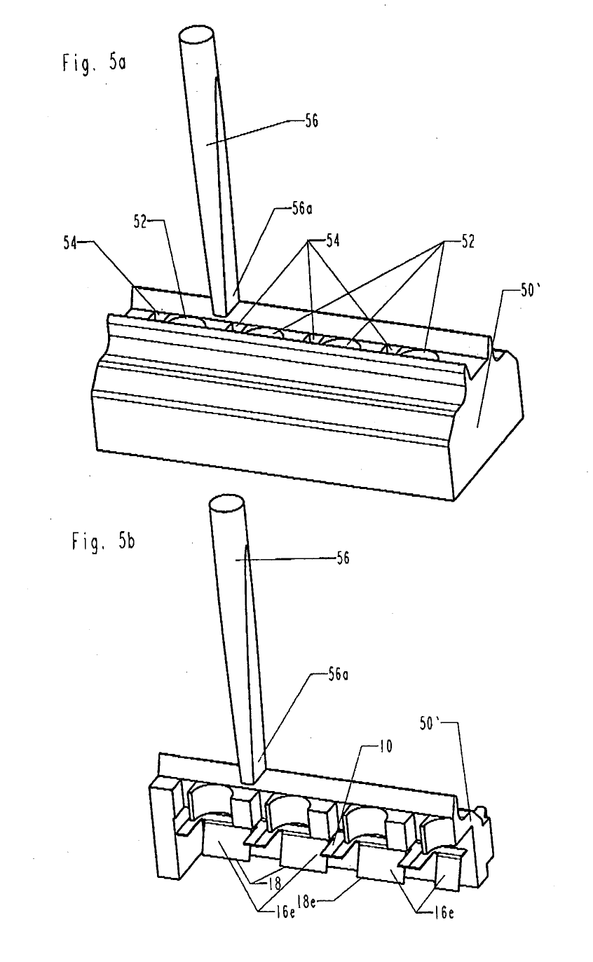

FIG. 5a shows a perspective view of a modified embodiment of the housing according to FIG. 4b;

FIG. 5b shows a partial cutaway perspective view of the housing together with the contact element according to FIG. 5a;

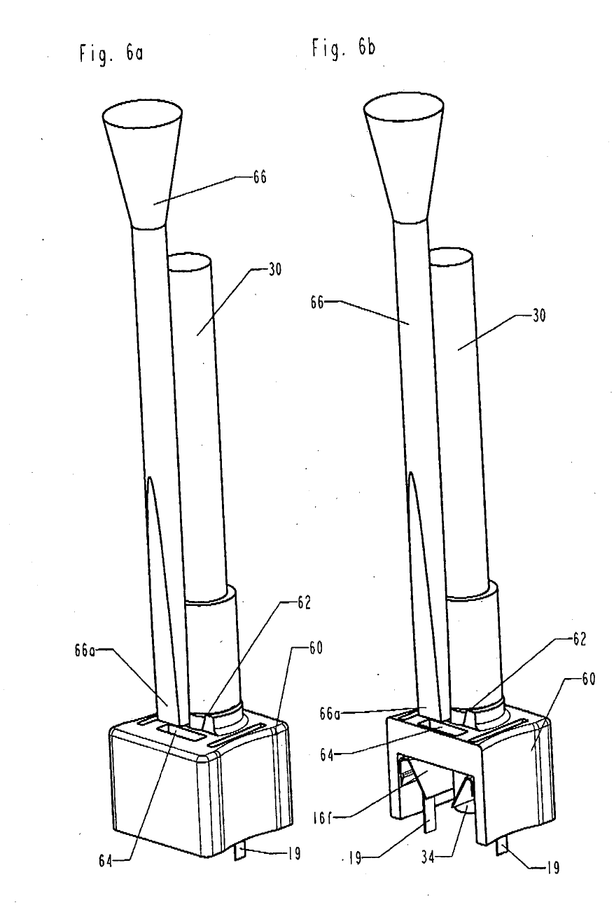

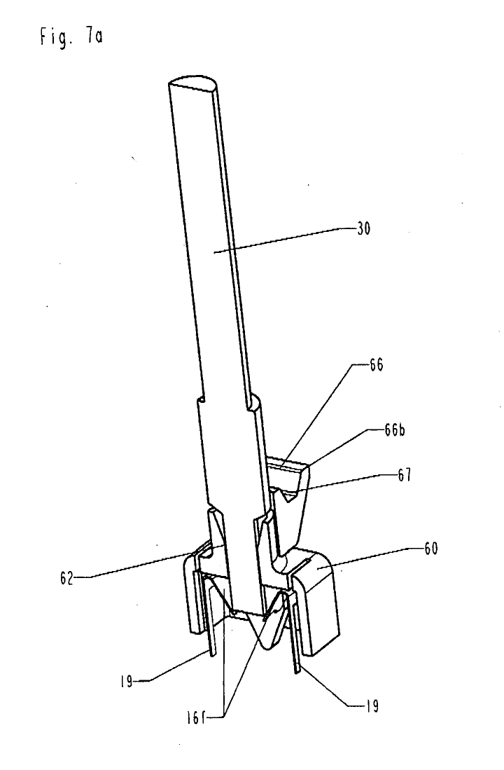

FIG. 6a shows a perspective view of a first exemplary embodiment of a connecting clip together with a contact element according to FIG. 1f, situated in a housing;

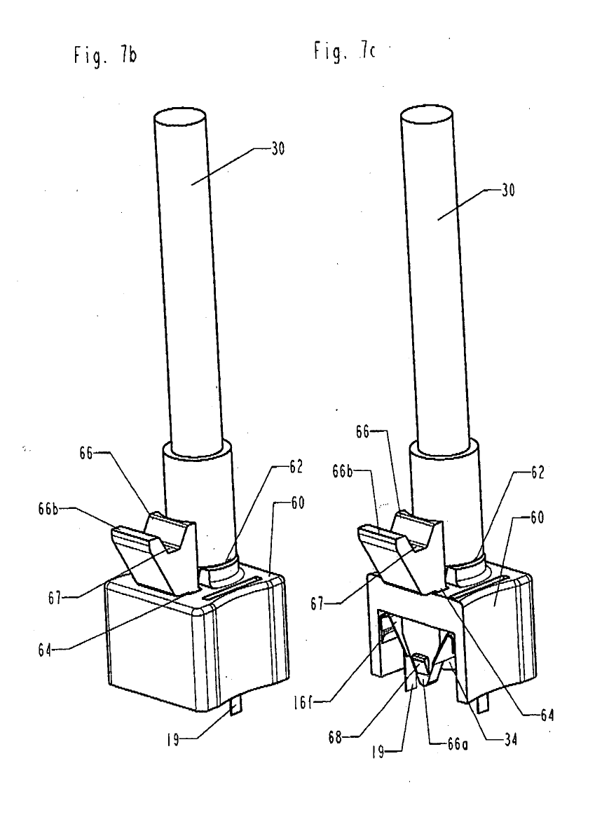

FIG. 6b shows a partial cutaway perspective view of the connecting clip according to FIG. 7a;

FIG. 7a shows a partial cutaway perspective view of a second exemplary embodiment of a connecting clip together with a contact element according to FIG. 1f, situated in a housing;

FIG. 7b shows a perspective view of the connecting clip according to FIG. 7a; and

FIG. 7c shows another partial cutaway perspective view of the connecting clip according to FIG. 7b.

FIGS. 1a through 1f show perspective views of six different exemplary embodiments of a contact element 10.

The contact element 10 according to a first exemplary embodiment illustrated in FIG. 1a has an essentially flat base element 12 manufactured from an electrically conductive material, preferably a metal such as copper or a copper alloy. The base element 12 has an essentially rectangular shape, and side walls 13 which are perpendicular to the plane of the base element 12 are provided at the edges to enable the contact element to be mounted on a printed circuit board, for example, although these side walls 13 do not necessarily have to be present. In the base element 12 a passage 14a is provided which has an essentially triangular shape. At its free end 18a a contact lug 16a adjoins the passage 14a, the contact lug 16a having an essentially rectangular, in particular square, shape, and preferably in the form of a leaf spring. The contact lug 16a and the passage 14a may be formed by a punching process, whereby a U-shaped punched opening is provided along three sides of the contact lug 16a and the triangular passage 14a is additionally punched in at the free end of the contact lug 16a or at the base of the U-shaped punched opening. The passage 14a has a very small diameter 15a which essentially corresponds to the height of the triangle which forms the passage 14a. This very small diameter 15a is smaller than the diameter of an electrical conductor to be inserted into the passage 14a.

FIG. 1b shows a second exemplary embodiment of the contact element 10, in which the base element 12 of this contact element 10 has no side walls, and instead is composed only of a flat, essentially rectangular, metal sheet. In the base element 12 a passage 14b is provided which is adjoined by three essentially triangular contact lugs at the free ends 18b thereof. The free end 18b of each of the contact lugs 16b is formed by one of the tips of the triangle which forms the contact lug 16b, whereas the contact lugs 16b are connected to the base element 12 at their sides oppositely situated from the tip. The contact lugs 16b and the passage 14a may in turn be punched from the base element 12 in a simple punching process. The tip which forms the free end 18b of the contact lugs 16b is blunt, the passage 14b being essentially formed by the blunt tips and imaginary connecting lines between each pair of adjoining free ends 18b. The smallest diameter 15b of the passage 14b thus formed is smaller than the diameter of the electrical conductor which is to be connected in the contact element 10, so that when an electrical conductor is pushed into the passage 14b, assurance is provided that the free ends 18b of the contact lugs 16b for the contact element 10 lie against the electrical conductor. To this end, the contact lugs 16b have a spring-like design in the manner of a leaf spring to ensure contact with the electrical conductor by elastic force.

A third exemplary embodiment of the contact element 10 is shown in FIG. 1c, the base element 12 for the contact element 10 having a passage 14c which is adjoined by the free ends 18c of four essentially triangular contact lugs 16c designed in the manner of a leaf spring. The triangular contact lugs 16c and the passage 14c are produced by a simple punching process, an essentially cross-shaped punched opening being punched into the base element 12, thereby producing the triangular contact lugs 16c between the legs of the cross-shaped punched opening. The tip which forms the free end 18c of the contact lugs 16c is blunt, the passage 14c essentially being formed by the blunt free ends 18c and imaginary connecting lines between each pair of adjoining free ends 18c.

The distance between the free ends 18c of oppositely situated contact lugs 16c defines the smallest diameter 15c of the passage 14c, and in turn is smaller than the diameter of an electrical conductor to be inserted.

According to a fourth exemplary embodiment in FIG. 1d, the contact element 10 has a passage 14d in the base element 12 which is adjoined by the tips of two essentially triangular contact lugs 16d designed as contact springs, these triangular contact lugs 16d and the passage 14d being formed by an essentially T-shaped punched opening in the base element 12, resulting in the triangular contact lugs 16d between the arms of the T. The passage 14d is thus essentially delimited by the region between the two free ends 18d and the center region of the transverse bar of the “T.” The smallest diameter 15d of the passage 14d essentially corresponds to the distance between the free ends 18d of the contact lugs 16d.

FIG. 1e illustrates an additional, fifth exemplary embodiment of the contact element 10, whereby in the essentially rectangular base element 12 of the contact element 10 four passages 14e are provided which are adjoined by the free ends 18e of each pair of essentially rectangular, preferably square, preferably leaf spring-like contact lugs 16e. After being formed by a punching process in which an essentially H-shaped punched opening is necessary, the contact lugs 16e are bent outward from the plane of the base element 12. In this manner a distinct insertion device is provided, since the electrical conductor can then be inserted only from the side into which the contact lugs 16e do not project. The passage 14e in each case is delimited essentially by the free ends 18e and each pair of imaginary connecting lines between the corners of the oppositely situated free ends 18e. The distance between the free ends 18e of each pair of contact lugs 16e adjoining one of the passages 14e defines the smallest diameter 15e. This diameter is smaller than the diameter of an electrical conductor to be connected. Thus, when an electrical conductor is inserted, the free ends 18e of the essentially rectangular contact lugs 16e lie against the electrical conductor. The contact element 10 according to the exemplary embodiment in FIG. 1e allows the simultaneous connection of multiple electrical conductors, thereby establishing an electrically conductive connection between the various electrical conductors since the base element 12 is made of an electrically conductive material, so that the contact element 10 according to FIG. 1e may be used as a shorting contact element.

A sixth exemplary embodiment of the contact element 10 is illustrated in FIG. 1f. In the base element 12 two essentially rectangular, preferably square, contact lugs 16f once again have been punched through an essentially H-shaped punched opening. The contact lugs 16f in particular have an elastic design in the manner of leaf springs. The contact lugs 16f are likewise bent outward from the plane of the base element 12 to define a distinct insertion device. The contact lugs 16f in each case have a free end 18f which, analogously to the exemplary embodiment according to FIG. 1e, defines a passage 14f and a very small diameter 15f. The smallest diameter 15f is once again smaller than the diameter of an electrical conductor to be connected, so that when an electrical conductor is inserted, the free ends 18f of the contact lugs 16f come to rest against the electrical conductor and establish the electrically conductive connection between the contact element and the electrical conductor. To allow the contact element 10 to be connected, for example, to a printed circuit board by the perforation technique, two connecting pins 19 are provided on the base element 12 which project essentially perpendicular to the plane of the base element 12 and which, for example, may be inserted into holes in the printed circuit board and soldered at that location, thereby establishing the electrical connection between the contact element 10 and the printed circuit board. The contact element 10 according to FIG. 1f once again has a side wall 13 along each edge of the base element 12, perpendicular to the plane of the base element 12, to provide a secure support for the contact element 10 when it is mounted on a substrate element, for example a printed circuit board or a housing.

FIGS. 2a through 2c schematically illustrate the various steps for connecting an electrical conductor to a printed circuit board. FIG. 2a shows in a perspective view a printed circuit board 20a on which an essentially rectangular contact surface 23a [sic; 23], connected to a printed conductor 21, is situated. An opening 22 is provided in the contact surface 23. The surface area of the contact surface 23 essentially corresponds to the surface area of the base element 12 of a seventh exemplary embodiment of the contact element 10. This contact element 10 has two rectangular, leaf spring-like contact lugs 16g which are formed by an essentially H-shaped punched opening. The contact lugs 16g lie in the plane of the base element 12. An essentially slot-shaped passage 14g is formed between the two free ends 18g of the contact lugs 16g. The smallest diameter 15g of the passage 14g essentially corresponds to the distance between the free ends 18g of the contact lugs 16g. As illustrated in FIG. 2a, the contact element 10 is mounted on the contact surface 23 of the printed circuit board 20a, and is connected in an electrically conductive manner by, for example, reflow soldering to the contact surface 23. The passage 14g comes to rest, at least partially, above the opening 22 in the contact surface 23 of the printed circuit board 20a.

FIG. 2b illustrates an electrical conductor 30 to be connected, having an electrically conductive core 34 which is encased with insulation 32. The diameter of the electrically conductive core 34 is considerably larger than the smallest diameter 15g of the passage 14g, but approximately corresponds to the diameter of the passage [sic; opening] 22. The electrical conductor 30 must be pushed into the opening 22 from the side of the printed circuit board 20a, which is opposite from the side on which the contact element 10 is situated, since only in this way is it ensured that the contact lugs 16g can be bent outward from the plane of the base element 12.

FIG. 2c illustrates the electrical conductor 30 connected in the contact element 10. The electrically conductive core 34 of the conductor 30 has been pushed through the opening 22 in the contact surface 23 of the printed circuit board 20a, thereby bending the contact lugs 16g outward from the plane of the base element 12 of the contact element 10. The free ends 18g of the contact lugs 16g slide for a distance along the electrically conductive core 34, and are pressed against the core 34 by elastic force and form the electrically conductive contact between the core 34 of the conductor 30 and the contact element 10, thus forming the contact surface 23 and the printed conductor 21 for the printed circuit board 20a. Electrical conductors may thus be connected to printed circuit boards in a particularly simple manner, since the electrical conductors need only be pushed into the contact element 10, and additional soldering is unnecessary.

By use of the contact elements 10 it is possible to connect not only individual electrical conductors, which may be formed from wire, for example, but also to connect entire components 40, as shown in FIGS. 3a and 3b. FIG. 3a illustrates the component 40 in a perspective view, having four connecting elements 42, for example. FIG. 3a also shows a perspective view of a printed circuit board 20b on which multiple contact elements 10 are provided on the surface of the printed circuit board 20b and are connected to various printed conductors 21 in the embodiment illustrated in FIGS. 2a through 2c. Four of the contact elements 10 are spaced apart from one another corresponding to the distance between the connecting elements 42 of the component 40. As shown in FIG. 3b, the component 40 may be easily mounted on the printed circuit board 20b by pushing the four connecting elements 42 through the passages 14g in the contact elements 10 so that the contact lugs 16g are deflected from the plane of the base element 12, but the free ends 18g of the contact lugs 16g come to rest against the connecting elements 42 in such a way that electrical contact is established between the connecting elements 42 and the printed conductors 21. The electrical contact is thus ensured by the elastic action of the contact lugs 16g, so that a further processing step such as soldering is unnecessary. At the same time, insertion of the component 40 into the contact elements 10 enables not only the electrical contact, but also a mechanical fixing of the component 40 on the printed circuit board 20b.

FIGS. 4a and 4b show the contact element 10 in the embodiment illustrated in FIG. 1e, in a partial cutaway view and in a perspective view, respectively, the contact element 10 being situated in a housing 50. The housing 50 has four input openings 52 which are configured relative to the contact element 10 such that the input openings 52 come to rest essentially in front of the passages 14e which are formed by the free ends 18e of the contact lugs 16e. By means of the input openings 52 it is thus possible to insert electrical conductors into the housing 50 and into the passages in the contact element 10, thereby ensuring via the contact lugs 16e the electrical contact between the contact element 10 and the inserted electrical conductor. Since the contact element 10 is manufactured in one piece from an electrically conductive material, four electrical conductors may be connected to one another via the contact element 10 so that the contact element 10 in the housing 50 functions as a shorting clip, and the housing 50 being used in particular as insulation for safety reasons when high voltages are applied. As illustrated in FIG. 4b, provided on the housing 50 are connecting contacts 58 which are connected to the contact element 10 in an electrically conductive manner, so that, by means of the housing 50 and the contact element 10, the electrical conductors connected in the contact element 10 may be provided with power via the connecting contacts 58, or may be connected to corresponding electrical components.

FIGS. 5a and 5b show a housing 50′ which is a modified embodiment of the housing 50 shown in FIGS. 4a and 4b, and which allows the electrical conductor connected in the contact element 10 to be easily removed from the contact element 10. For this purpose the housing 50′ has a release opening 54, next to each input opening 52, through which a release tool 56 may be inserted into the housing 50′ in order to deflect the contact lugs 16a and release them from the inserted electrical conductor. This releases the clip for the conductor between the contact lugs 16e, allowing the electrical conductor to be removed from the contact element 10. As illustrated in FIGS. 5a and 5b, the release tool 56 is designed, for example, as the working end of a screwdriver or in a similar manner, the release tool 56 having an application end 56a which is applied against the contact lugs 16e through the release opening 54 in order to downwardly deflect the contact lugs 16e in FIG. 5b. This increases the distance between the free ends 18e, thereby releasing the free end 18e lying against the electrical conductor (not illustrated) from the electrical conductor so that the electrical conductor may be removed from the contact element 10.

FIGS. 6a and 6b illustrate in a perspective view and in a partial cutaway view, respectively, a housing 60 in which a contact element 10 according to the exemplary embodiment illustrated in FIG. 1f is provided. The contact element 10 may be soldered to the housing 60, for example on a printed circuit board, via the connecting pins 19. The housing 60 together with the contact element 10 forms a connecting clip for the electrical conductor 30 illustrated in FIGS. 6a and 6b. The housing 60 has an input opening 62 through which the electrical conductor 30 is inserted into the housing 60, and between which the two contact lugs 16f, which lie with their free ends 18f against the electrically conductive core 34 of the electrical conductor 30, may be held. Next to the input opening 62 a release opening 64 is provided in the housing 60, through which a release tool 66 may be inserted into the housing 60. The release tool 66 has an application end 66a which is inserted into the housing 60 through the release opening 64 and which is applied against the contact lugs 16f in order to push the contact lugs apart. The application end 66a has a width that is greater than the diameter of the electrically conductive core 34 of the electrical conductor 30 in order to push the two contact lugs 16f far enough apart so that the free ends 18f of the contact lugs 16f no longer rest against the electrically conductive core 34 of the electrical conductor 30, thus allowing the electrical conductor 30 to be removed from the contact element 10 and the housing 60 without resistance. The release tool 66 may be designed as a screwdriver, for example, although specially manufactured release tools 66 may also be provided.

Instead of a separate release tool 66 as illustrated in FIGS. 6a and 6b, as an alternative a release tool 66′ may be permanently installed in the housing 60, as illustrated in FIGS. 7a, 7b, and 7c. FIGS. 7a and 7c show a partial cutaway view of the housing 60, whereas FIG. 7b shows a perspective view thereof together with the permanently installed release tool 66. The release tool 66′ has an application end 66a which is located in the housing 60, and also has an actuation end 66b located outside the housing 60. The release tool 66′ is situated in the release opening 64, and in particular is displaceable in the release opening 64. To prevent the release tool 66′ from being completely removed from the release opening 64, a projection 68 is provided on the application end 66a for preventing the release tool 66 from being pulled from the release opening 64. The application end 66a of the release tool 66′ has an essentially wedge-shaped design to enable insertion between the two contact lugs 16f. The width of the application end 66a is greater than the diameter of the electrically conductive core 34 of the electrical conductor 30, so that by use of the release tool 66′ the contact lugs 16f may be pushed far enough apart so that the free ends 18f no longer rest against the electrically conductive core 34 of the electrical conductor 30. By pressing on the actuation end 66b, the release tool 66 may be displaced inside the release opening 64 in order to push the contact lugs 16f apart. The actuation end 66b preferably has a slot-shaped recess 67 in which, for example, the working end of a screwdriver may be inserted in order to reach the actuation end even when the housing 60 is located in poorly accessible locations.

### LIST OF REFERENCE NUMERALS

10 Contact element
12 Base element
13 Side wall
14a Passage
14b Passage
14c Passage
14d Passage
14e Passage
14f Passage
14g Passage
15a Diameter
15b Diameter
15c Diameter
15d Diameter
15e Diameter
15f Diameter
15g Diameter
16a Contact lug
16b Contact lug
16c Contact lug
16d Contact lug
16e Contact lug
16f Contact lug
16g Contact lug
18a Free end
18b Free end
18c Free end
18d Free end
18e Free end
18f Free end
Free end
Connecting pin
Printed circuit board
Printed circuit board
Printed conductor
Opening
Contact surface
Electrical conductor
Insulation
Core
Component
Connecting element
Housing
Housing
Release opening
Release tool
Application end
Connecting contact
Housing
Input opening
Release opening
Release tool
Release tool
Application end
Actuation end
Recess
Projection

1. Contact element (10) for connecting an electrical conductor (30), comprising a flat electrically conductive base element (12) in which at least one passage (14a, 14b, 14c, 14d, 14e, 14f, 14g) is provided, the smallest diameter (15a, 15b, 15c, 15d, 15e, 15f, 15g) of which is smaller than the diameter of the electrical conductor (30), and wherein at least one contact lug (16a, 16b, 16c, 16d, 16e, 16f, 16g) with its free end (18a, 18b, 18c, 18d, 18e, 18f, 18g) adjoins the passage (14a, 14b, 14c, 14d, 14e, 14f, 14g), and the contact lug (16a, 16b, 16c, 16d, 16e, 16f, 16g) is designed in such a way that when an electrical conductor (30) is inserted, the contact lug lies with its free end (18a, 18b, 18c, 18d, 18e, 18f, 18g) against the electrical conductor (30).

2. Contact element according to claim 1,
characterized in that two to eight contact lugs (16b, 16c, 16d, 16e, 16f, 16g) with their free ends (18b, 18c, 18d, 18e, 18f, 18g) adjoin the passage (14b, 14c, 14d, 14e, 14f, 14g).

3. Contact element according to claim 1, characterized in that multiple, preferably at least three, passages (14e) are provided in the base element (12).

4. Contact element according to claim 1, characterized in that the contact element (10) is designed as a punched element.

5. Contact element according to claim 1, characterized in that (12) at least one connecting pin (19) is provided on the base element, perpendicular to the plane of the base element (12).

6. Contact element according to claim 1 characterized in that the contact element (10) is situated in an insulating housing (50, 50′, 60), and input openings (52, 62) are provided in the housing (50, 50′, 60) in such a way that the electrical conductor (30) may be pushed through the input openings (52, 62) of the housing (50, 50′, 60) and into the passages (14e, 14f) in the base element (12).

7. Contact element according to claim 6,
characterized in that release openings (54, 64) are provided in the housing (50′, 60) in such a way that a release tool (66) may be pushed through the release openings against at least one contact lug (16e, 16f) of the base element (12) in order to deflect the at least one contact lug (16e, 16f) and release it from the inserted electrical conductor (30) to allow the electrical conductor (30) to be removed from the contact element (10).

8. Contact element according to claim 7,
characterized in that in at least one release opening (54, 64) a release tool (66) is provided which has an end (66a) to be applied to the contact lug, and an actuation end (66b) which may be displaced in the release opening (54, 64), the end (66a) to be applied against the contact lug (16e, 16f) being situated in the housing (50′, 60), and the actuation end (66b) being situated outside the housing (50′, 60).

9. Contact element according to claim 7, characterized in that
the release tool (66) has a wedge-shaped design at the end (66a) to be applied against the contact lug (16e, 16f).

10. Use of a contact element (10) according to claim 1 for connecting an electrical conductor, in particular a connecting wire, in particular to a printed circuit board.

11. Method for connecting a electrical conductor, in which an electrically conductive contact element (10) is mounted on a substrate element, the contact element (10) having a passage (14a, 14b, 14c, 14d, 14e, 14f, 14g), the smallest diameter (15a, 15b, 15c, 15d, 15e, 15f, 15g) of which is smaller than the diameter of the conductor (30), and at its free end (18a, 18b, 18c, 18d, 18e, 18f, 18g) at least one contact lug (16a, 16b, 16c, 16d, 16e, 16f, 16g) adjoins the passage, and in which the conductor (30) is then guided through the passage (14a, 14b, 14c, 14d, 14e, 14f, 14g), at its free end (18a, 18b, 18c, 18d, 18e, 18f, 18g) the at least one contact lug (16a, 16b, 16c, 16d, 16e, 16f, 16g) lying against the electrical conductor (30), and the electrical conductor (30) then being held in a clamped manner by the at least one contact lug (16a, 16b, 16c, 16d, 16e, 16f, 16g), thereby establishing the electrical contact via the contact lug (16a, 16b, 16c, 16d, 16e, 16f, 16g).

12. Method according to claim 11,
characterized in that the substrate element is a printed circuit board (20a, 20b) or an insulating housing (50, 50′, 60).
